(19) United States
(12) Patent Application Publication
(10) Pub. No.: US 2015/0204415 A1
(43) Pub. Date: Jul. 23, 2015

(54) VIBRATION ISOLATION ASSEMBLY FOR CONCRETE SAWS

(71) Applicant: MULTIQUIP, INC., CARSON, CA (US)

(72) Inventors: NATHANIEL BATEMAN, BOISE, ID (US); COLE BAIRD, BOISE, ID (US)

(21) Appl. No.: 14/600,849

(22) Filed: Jan. 20, 2015

Related U.S. Application Data
(60) Provisional application No. 61/929,448, filed on Jan. 20, 2014.

(51) Int. Cl. F16F 15/08; B28D 1/04

(52) U.S. Cl. CPC F16F 15/08; B28D 1/045

(57) ABSTRACT

The present disclosure is a vibration dampening assembly for a walk behind concrete saw having a frame and deck assembly, an engine mounted to the top of the deck, a pair of rear wheels interconnected by a nonrotating solid axle which spans the width of the deck and is attached to the frame, and a handlebar post having a lower portion, a pair of outer, generally rectangular, damper blocks, having a front portion and a rear portion, attached to the underside of the deck in parallel juxtaposed relationship; front and rear cross members for interconnecting the front and rear portions of the outer damper blocks to form a generally rectangular grid frame; a pair of inner, generally rectangular, damper blocks attached to the lower portion of the handlebar post in a position where there is no metal to metal contact between the lower portion of the handlebar post and the deck; and means for attaching the inner damper blocks to the front and rear cross members.

### CLAIM TO PRIORITY

This Application claims priority to currently pending U.S. Patent Application No. 61/929,448, originally filed Jan. 20, 2014, which is herein incorporated by reference.

### FIELD OF INVENTION

This invention generally relates to walk behind, concrete saws, and more particularly to a vibration isolation assembly for the operators handle.

### BACKGROUND OF THE INVENTION

The basic components or subassemblies of a prior art walk behind concrete saw are shown on FIG. 1, and include a deck, or frame assembly with a set of wheels mounted underneath to facilitate moving the saw, an engine, typically a one cylinder, gasoline powered engine rigidly mounted to the deck or frame, a saw blade assembly which is elevationally adjustable up and down for lowering the saw blade into the concrete to be cut and raising it out again, a drive system for operatively connecting the engine to the blade, and a handle bar assembly having a handle bar, and means for mounting the engine throttle control and depth of cut controls. In some designs means for powering the wheels so as to provide a self propelled saw are provided; in others, self propelled drive is provided, and the saw is simply pushed forward manually by the operator as the saw is cutting.

Walk behind concrete saws inherently vibrate, and there are a number of contributing sources to the vibration, including the running engine, the rotating saw blade, the impact of the saw blade with the aggregate in the concrete being cut, and the saw blade drive system, which is usually a belt and pulley assembly. All of these sources of vibration occur at different frequencies and are transferred or imparted to the deck and frame assembly at different locations and this will result in unexpected, and possibly unanticipated, multiple harmonic vibrations that must be empirically ascertained once the new design is assembled and operated.

This makes it extremely difficult, if not impossible to reduce the level of vibration at the operators handle bars by designing the handle in such a manner so as to locate the operators handle bars at a null point in the harmonic oscillations imparted to the handle bar assembly. That would be the ideal way to reduce vibration, but the vibrations imparted to the handle are too complex and varied. A second method of reducing the handle bar vibration would be to shock mount the handle bars using soft, vibration absorbing resilient mounts, similar to those used sound isolate electrical motors. But the problem with that type of design is that the handle assembly must be capable of withstanding substantial forces imposed by the operator during cutting operations.

Typically when a cut is to be made using a walk behind concrete saw, the saw is first manually positioned to align the raised saw blade in the desired location for the cut, and positioned in the correct direction for the desired cut. With the blade still in an elevated position about the concrete to be cut, the engine is then started, and the rotating blade slowly driven into the concrete to the desired depth of cut. Then either the drive system is engaged, and the operator pushes the saw slowly forward to cut along the desired line of cut.

Under ideal or theoretical conditions, once the saw is properly aligned, the operator should be able to simply walk behind the saw, as the saw propels itself forward, or if no drive system is provided, the operator pushes the saw along the desired line of cut. However that is not what happens. If the saw blade and its attendant mounting spindle is slightly misaligned, even by just a few minutes of a degree, the saw blade will veer off to the left or right from the desired straight line of cut. For example, a saw blade that is misaligned by just 1° the saw will veer off by 3.12 feet in a 100 foot cut. Saw blade operators compensate for this commonplace misalignment by “steering” the saw, either by pressuring it in one direction or the other, or more commonly, stopping the advancement of the cut, raising the blade out of the cut and realigning the saw blade. This usually requires pulling the saw back along the cut and lowering the blade back into the cut at a point where it can be again “steered” in the correct line of cut direction. This type of activity imparts considerable mechanical forces on the hand bar assembly, which renders the use of soft, resilient, vibration absorbing, handlebar mounts unfeasible. As a result no attempt to reduce handle bar vibration is even made.

### SUMMARY OF THE INVENTION

A walk behind concrete saw of a typical construction, but incorporating a vibration dampening isolation system is provided. The main components are a deck which can either be fabricated of sheet steel, or cast. Attached to the deck are side plates which together form a deck and frame assembly. An engine is mounted directly to the deck and has a horizontal side output from the internal crank shaft. A saw blade is attached to an arbor and spindle assembly which is encased within the front most portion of the deck frame. Drive for the saw blade is provided typically by a belt and pulley arrangement encased within a drive belt shroud. The saw blade is also encased in a saw blade shroud to which it is attached a dust exhaust pipe.

The saw rides on one or two front wheels and a pair of rear wheels and the deck is tiltable by means of blade depth control assembly to tilt the deck upward at the front to withdraw the saw blade from the concrete it is cutting and likewise lowerable to drive the saw blade into the concrete to the desired depth of cut. There is a handle bar post extending rearwardly upward to horizontal handle bars.

Elevational control of the front of the deck is provided by blade depth control assembly which typically has a pitman arm arrangement for a vertical control rod which translates the rotation of an operator's handle which in turn pivots a push plate at the front of the pivot arm to elevate the front of the deck above it.

There is no powered drive system and the saw is advanced by the operator walking behind the saw pushing it slowly forward to make the cut.

When the saw is being used to cut vibrations naturally occur as a result of the running engine, and also as the result of the engagement of the saw blade with the concrete and the aggregate found within it. Additional vibration is also caused by the belt and pulley drive system powering the saw blade. The result is a complex set of vibrations and harmonics thereof which are transmitted ultimately to the deck which serves as the frame for the whole saw. Based upon empirical testing using a hand held accelerometer, it has been found that the vibration amplitude is not uniform across the surface of the deck, and in the case of one prototype it was found that maximum vibration amplitude was to be found in the extreme right rear corner of the deck when viewed from the operators position behind the saw assembly and handlebars. The goal of the vibration isolation system is to isolate the handle bar post and handle bars from the frame so as to reduce the vibration experienced by the operator when cutting.

This is accomplished through incorporation of a pair of spaced apart outer damper blocks and inner damper blocks which are interconnected and to which the handle bar post is attached. The front wheels of the saw are attached to a front axle. The rear wheels are attached to and rotate about a stationery and solid rear axle. The rear axle is attached to frame side panels and does not rotate. The rear axle also serves as a rear crossmember support for the rear portions of outer and inner elastomeric damper blocks. Located outboard of the rear wheels are mounted outer the elastomeric damper blocks which are mounted from the top down by means of mounting bolts extending downwardly through the deck and through the outer elastomeric damper blocks so as to attach the outer elastomeric damper blocks directly to the vibrating deck. The damper block are designed to be in close proximity to side panels of the deck, but are not directly mounted thereto thus the vibrations experienced on the deck are transmitted to the outer elastomeric outer vibration dampers strictly by directly fastening the outer damper blocks to the deck using through bolts. The front portions of the damper blocks are attached to a front cross member which extends completely across from one outer damper block to the other. The inner damper blocks are held in place at their front portions by means of a pair of through bolts which clamp the forward ends of inner damper blocks to a pair of spacer blocks of approximately the same width as the width of the handle bar post. The spacer blocks are designed and configured to frictionally fit and crimp onto the forward cross brace to lock the inner damper blocks into position so as to make it in a center position between the two outer damper blocks by means of frictional engagement. The rearward portions of the inner damper blocks are directly attached to the upwardly extending handle bar post by means of through bolts. Neither the rear most portion of inner damper blocks 42 and the rear most portion of the outer damper blocks are not attached to the rear axle but instead are simply located by means of the through holes in the damper blocks which also serve as a bearing surface for locating and positioning the rear portions of the inner damper blocks.

A pair of damper block braces are attached to the outer most surfaces of the inner damper blocks. They are not in metal to metal contact with the deck, frame or any other metal which is in contact with the vibrating deck or the sources of vibration, and serve to reinforce the inner damper blocks for purposes of preventing distortion of the inner damper blocks when placed in compression against the lower most portion of the handle bar post and the spacers. By stiffening the inner damper blocks, it adds rigidity to their connection to the handle bar post.

The inner and outer damper blocks can be fabricated from a variety of different elastomeric materials with good vibration absorbing, or hysteretic damping, characteristics including Neoprene and various thermoplastics.

In this vibration damping design there is no metal to metal contact between the metal handle bar post and the deck. All vibrational energy from the deck must first pass through inner and outer damper blocks where they are attenuated. It is understood that the energy imparted by the vibration is converted by the elastomeric material of vibration the damper blocks as low grade heat which is dissipated to the atmosphere. And given the spaced apart relationship between the outer damping blocks and the inner damping blocks, and the fact that only the outer damping blocks are in contact with the vibrating deck, they can be positioned, in a tuned manner, for attachment to the deck at an empirically determined low vibration nodes on deck, so as to further attenuate the vibrations imparted to the handle bar post.

The purpose of the Summary of the Invention is to enable the public, and especially the scientists, engineers, and practitioners in the art who are not familiar with patent or legal terms or phraseology, to determine quickly from a cursory inspection, the nature and essence of the technical disclosure of the application. The Summary of the Invention is neither intended to define the invention of the application, which is measured by the claims, nor is it intended to be limiting as to the scope of the invention in any way.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the descriptions of the preferred embodiments are to be regarded as illustrative in nature, and not as restrictive in nature.

### BRIEF DESCRIPTION OF THE DRAWINGS

FIG. 1 is a side view of an assembled walk behind concrete saw showing the attachment points for the vibration isolation assembly.

FIG. 2 is a perspective representation view of the vibration isolation assembly attached to the wheels, and the handle bar post assembly.

FIG. 3 is a sectional bottom plan view of the vibration isolation assembly attached to the underside of the frame and deck assembly.

### DESCRIPTION OF THE PREFERRED EMBODIMENTS

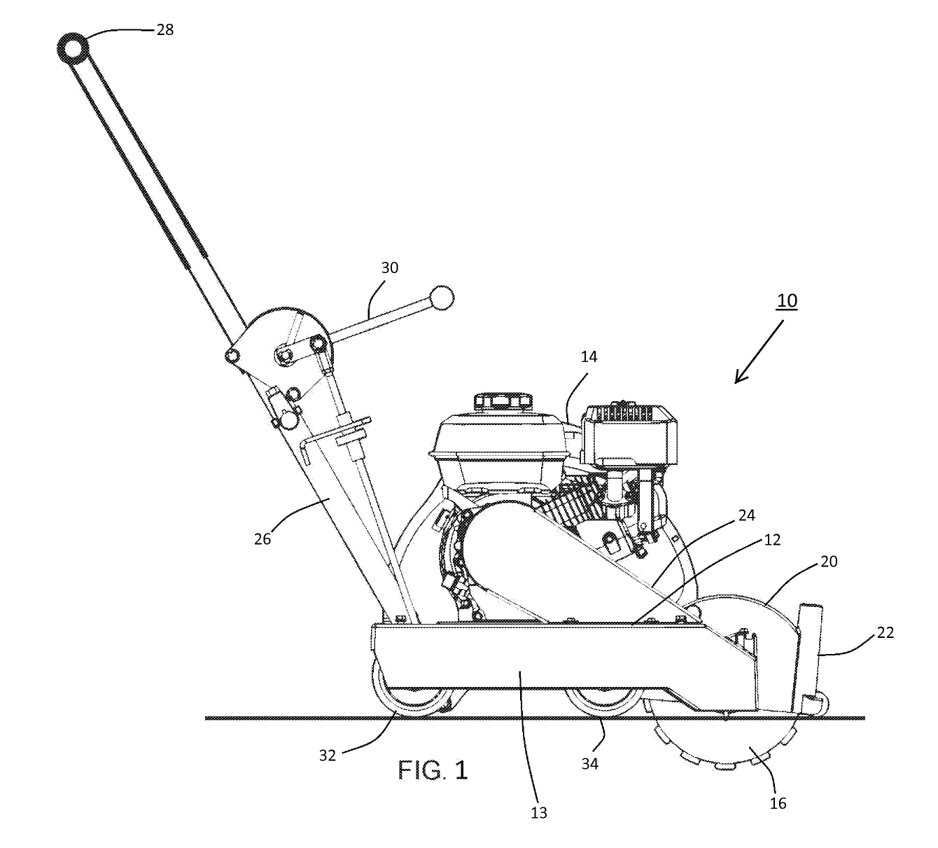

First referring to FIG. 1 there is shown and described a walk behind concrete saw 10 of a typical construction, but incorporating our new vibration dampening isolation system. The main components of the saw assembly are deck 12 which can either be fabricated of sheet steel, or cast. Attached to the deck 12 are side plates 13 to form a deck and frame assembly. Engine 14 is mounted directly to the deck and has a horizontal side output from the internal crank shaft (not shown). Saw blade 16 is attached to an arbor and spindle assembly which is encased within the front most portion of deck frame 12. Drive for the saw blade is provided typically by a belt and pulley arrangement encased within drive belt shroud 24. The saw blade 16 is also encased in saw blade shroud 20 to which it is attached to dust exhaust pipe 22.

As shown in FIG. 1, the saw rides on front wheels 34 and rear wheels 32 and the deck 12 is tiltable by means of blade depth control assembly 30 to tilt the deck upward at the front to elevate the saw blade from the concrete to be cut, and likewise lowerable to drive the saw blade into the concrete to the desired depth of cut. There is a handle bar post 26 extending rearwardly upward to horizontal handle bars 28.

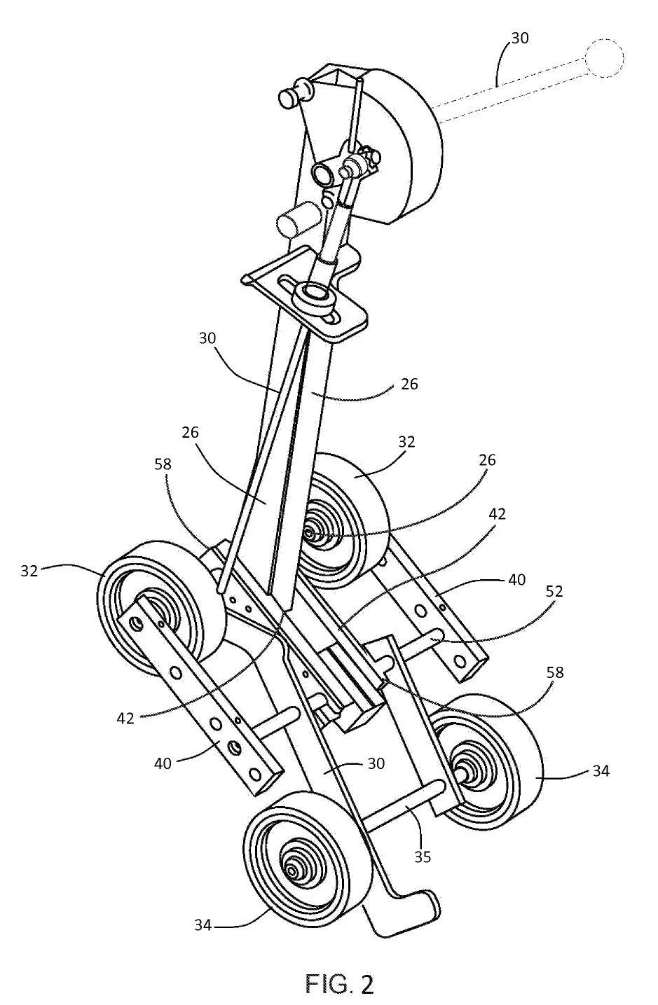

Elevational control of the front of deck 12 is provided by blade depth control assembly 30. It plays no part in the invention, but is merely for illustrative purposes and it has a pitman arm arrangement for a vertical control rod which translates the rotation of the operator's handle shown in FIGS. 1 and 2 which in turn upwardly pivots the push plate at the front of the pivot arm to elevate the front portion the deck above it.

In this preferred embodiment there is no powered drive system and the saw is advanced by the operator walking behind the saw pushing it slowly forward to make the cut.

When the saw is being used to cut vibrations naturally occur as a result of the running engine, and also as the result of the engagement saw blade 16 with the concrete and the aggregate found within it. Additional vibration is also caused by the belt and pulley drive system powering the saw blade 16. The result is a complex set of vibrations and harmonics thereof which are transmitted ultimately to the deck which serves as the frame for the whole saw assembly. Based upon empirical testing using a hand held accelerometer, it has been found that the vibration amplitude is not uniform across the surface of the deck, and in the case of one prototype it was found that maximum vibration amplitude was to be found in the extreme right rear corner of the deck when viewed from the operators position behind the saw assembly and handlebars. The goal of the vibration isolation system is to isolate the handle bar post 26 and handle bars 28 from the frame so as to reduce the vibration experienced by the operator when cutting.

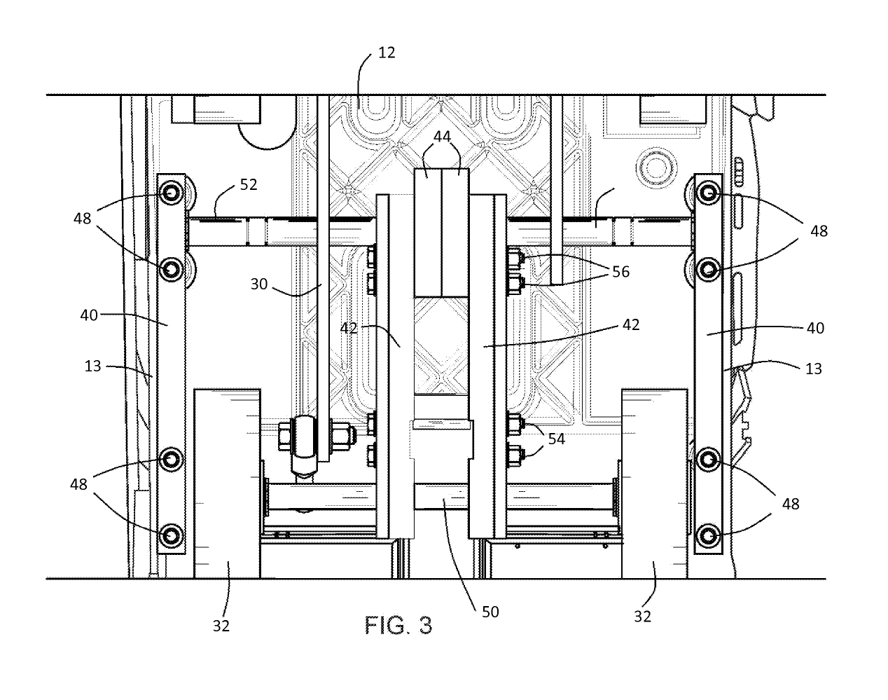

As shown in FIG. 3 this is accomplished through incorporation of a pair of outer damper blocks 40 and inner damper blocks 42 which are interconnected and to which handle bar post 26 is attached. As can be seen clearly in FIG. 2, front wheels 34 are attached to a front axle 35. The rear wheels 32 are attached to and rotate about a stationary and solid rear axle 50. Rear axle 50 is, in the preferred embodiment, attached to frame side panels 13 and does not rotate. In the preferred embodiment, rear axle 50 also serves as a rear crossmember support for the rear portions of outer and inner elastomeric damper blocks 40 and 42. Located outboard of rear wheels 32 are mounted outer elastomeric damper blocks 40 which are mounted from the top down by means of mounting bolts 48 extending downwardly through deck 12 and through outer elastomeric damper blocks 40 so as to attach the elastomeric damper blocks 40 directly to the underside of the vibrating deck. The damper block is designed to be in close proximity to side panels 13 but is not directly mounted thereto thus the vibrations experienced on the deck 12 are transmitted to outer elastomeric box 40 strictly by means of the direct fastening using through bolts 48. The front portions of the damper blocks are attached to front cross member 52 which extends completely across from one outer damper block 40 to the other.

It should be pointed out that while in the preferred embodiment rear axle 50 serves double duty as a rear cross member, other designs may utilize a separate rear crossmember in lieu of the rear axle. This is particularly true in situations where the vibration damping system is “tuned” to a particular deck design so as to locate the attached outer damping blocks are located at lower vibration or vibration null sites or locations.

Inner damper blocks 42 are held in place at their front portions by means of a pair of through bolts 56 which clamp the forward portions of inner damper blocks 42 to a pair of spacer blocks 44. The spacer blocks 44 are designed to frictionally fit and crimp onto forward cross brace 52 to lock the inner damper blocks 42 into position so as to make it in a center position between the two outer damper blocks 40 by means of frictional engagement. The rearward portion of inner damper blocks 42 are attached to the upwardly extending handle bar post 26 by means of through bolts 54. Neither the rear most portion of inner damper blocks 42 or the rear most portions of the outer damper blocks 40 are attached to rear axle 50 but instead are simply located by means of the through holes in the damper blocks although rear axle 50 also serves as a bearing surface for locating, positioning and holding up the rear portions of the inner damper blocks 42.

A pair of damper block, flat metal braces 58 are attached to the outer most surfaces of the inner damper blocks 42. In the preferred embodiment they are not in metal to metal contact with the deck, frame or any other metal which is in contact with the vibrating deck or the sources of vibration. The metal braces 58 serve to reinforce the inner damper blocks 42 for purposes of preventing distortion of the inner damper blocks 42 when placed in compression against the lower most portion of handle bar post 26 and spacers 44.

Damper blocks 40 and 42 can be fabricated from a variety of different elastomeric materials with good vibration absorbing, or hysteretic damping, characteristics including Neoprene and various thermoplastics. When these materials are deformed, internal friction causes high energy losses to occur. The loss factor is the ratio of energy dissipated from the system to the energy stored in the system for every oscillation. A loss factor of 0.1 is generally considered a minimum value for significant damping.

In this manner, there is no metal to metal contact between the metal handle bar post 26 and deck 12. All vibrational energy must first pass through inner and outer damper blocks 42 and 40 where they are attenuated. It is understood that the energy imparted by the vibration is converted by the elastomeric material of vibration damper blocks 42 and 40 as low grade heat which is dissipated to the atmosphere. And given the spaced apart relationship between the outer damping blocks 40 and in the inner damping blocks 42, and the fact that only the outer damping blocks 40 are in contact with the vibrating deck 12, the outer damping blocks 42 can be positioned, in a tuned manner, for attachment to the deck 12 at empirically determined low vibration nodes on deck 12, so as to further attenuate the vibrations imparted to handle bar post 26.

Thus having shown and described a preferred embodiment, it should be apparent to anyone skilled in the art that the inventive principles of the present invention can be incorporated in a variety of different designs for isolating the handle bar post 26 from the vibrations imparted by the various moving components of a concrete saw. Additionally, these same inventive principles can be incorporated into the design of a self-propelled concrete saw as well as the manual saw of varying sizes and masses. The design as shown in the preferred embodiment is merely for illustrative purposes.

1. A vibration dampening assembly for a walk behind concrete saw having a frame and deck assembly, an engine mounted to the top of the deck, a pair of rear wheels interconnected by a nonrotating solid axle which spans the width of the deck and is attached to the frame, and a handlebar post having a lower portion, which comprises:
a pair of outer, generally rectangular, damper blocks, having a front portion and a rear portion, attached to the underside of the deck in parallel juxtaposed relationship;
front and rear cross members for interconnecting the front and rear portions of the outer damper blocks to form a generally rectangular grid frame;
a pair of inner, generally rectangular, damper blocks attached to the lower portion of the handlebar post in a position where there is no metal to metal contact between the lower portion of the handlebar post and the deck; and
means for attaching the inner damper blocks to the front and rear cross members.

2. The vibration dampening assembly of claim 1 wherein the rear axle is the rear cross member.

3. The vibration dampening assembly of claim 1 wherein the generally rectangular dampening blocks are formed of vibration absorbing elastomeric materials.

4. The vibration dampening assembly of claim 3 wherein the vibration absorbing elastomeric material has a energy loss factor ratio of at least 0.1.

5. The vibration dampening assembly of claim 1 which further comprises metal reinforcing plates attached to the sides of the inner generally rectangular damping blocks not in contact with the handlebar post.
